(19) United States
(12) Patent Application Publication
(10) Pub. No.: US 2002/0173297 A1
(43) Pub. Date: Nov. 21, 2002

(54) Call forwarding features in mobile wireless communication devices and methods therefor

(76) Inventor: Alexander Lynn Phillips, Woodinville, WA (US)

Correspondence Address: Motorola, Inc., Intellectual Property Section, Law Department, 600 North U.S. Highway 45, AN475, Libertyville, IL, 60048, US

(21) Appl. No.: 09/861,118

(22) Filed: May 18, 2001

(51) Int. Cl. H04M 3/42

(52) U.S. Cl. 455/417; 455/414; 379/211.02

(57) ABSTRACT

Methods for forwarding wireless communications in mobile wireless communication devices, for example cellular handsets, including storing a plurality of communication addresses in association with corresponding geographical areas on the mobile wireless communication device, determining a location of the device (220), determining at the mobile wireless communication device whether a stored communication address has been associated with a geographical location of the device (230), and forwarding wireless communications to a communication address associated with the geographical location of the mobile wireless communication device (260).

### FIELD OF THE INVENTIONS

The present inventions relate generally to mobile wireless communication devices, and more particularly to wireless communications forwarding features in mobile wireless communication devices and methods therefor.

### BACKGROUND OF THE INVENTIONS

Many cellular telephone communication service provider plans allow cellular subscribers to manually forward incoming telephone calls, directed initially to the subscriber's handset, to an alternate telephone number. In some subscriber plans, for example, user's forward calls by depressing “*72” or some other key sequence, entering a forwarding telephone number and then depressing the “send” key. In known call forwarding schemes however users must manually enter a different forwarding number for each different location where they would like calls forwarded.

It is known to store several forwarding numbers each correlated with a specific service area in a home location register (HRL) associated with a particular mobile station, and to forward calls to the forwarding number associated with the particular service area in which the mobile station is located. U.S. Pat. No. 5,978,673 entitled “Providing Location-Based Call Forwarding Within A Mobile Telecommunications Network”. The storage, correlation and forwarding of calls in U.S. Pat. No. 5,978,673 all occur on the network side of the communication system.

Other known call forwarding schemes forward calls by modeling the subscriber's activity to predict where the subscriber is likely to be reached based upon past behavior. U.S. Pat. No. 5,905,789 entitled “Call-Forwarding Scheme Using Adaptive Model of User Behavior”. The modeling in U.S. Pat. No. 5,905,789 is performed on the network side of the communication system.

The various aspects, features and advantages of the present inventions will become more fully apparent to those having ordinary skill in the art upon careful consideration of the following Detailed Description of the Invention and the accompanying drawings described below.

### BRIEF DESCRIPTION OF THE DRAWINGS

FIG. 1 is a process flow diagram for associating communication addresses with corresponding geographic locations.

FIG. 2 is process flow diagram for forwarding wireless communications in a mobile wireless communication device.

FIG. 3 is a schematic block diagram of a mobile wireless communication device.

### DETAILED DESCRIPTION OF THE INVENTIONS

The present invention relates generally to methods for automatically forwarding wireless communications, sent initially to mobile wireless communication devices, to one of several other communication addresses. The particular communication address to which the wireless communications are forwarded is dependent generally upon the location of the mobile wireless communication device at the time the communication is transmitted to the mobile wireless communication device.

In one exemplary embodiment, the wireless communication device is a cellular handset and the wireless communications are telephone calls. In other embodiments however the wireless communications may be pages sent to a pager, or e-mail sent to a wireless enabled laptop computer or personal digital assistant, or other wireless communication device, and more generally any wireless communications transmitted to a mobile wireless communication device.

In one embodiment of the invention, one or more forwarding communication addresses, e.g., telephone numbers, are each associated with corresponding geographical locations, e.g., home, office, etc.

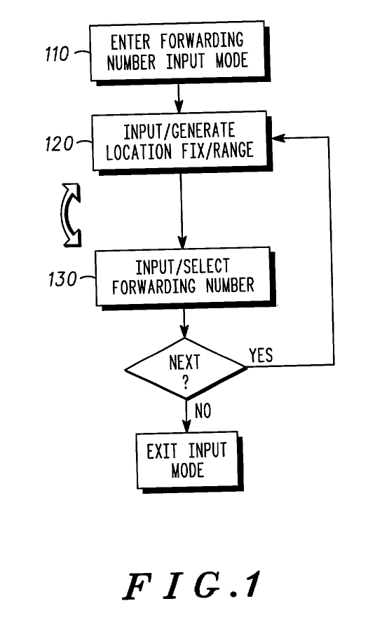

In the exemplary process flow diagram of FIG. 1, the forwarding communications addresses are each associated with a corresponding geographical location at the mobile wireless communication device by entering a “forwarding input” mode, at block 110. In one embodiment, this mode is a software implemented mode or configuration of the mobile wireless communication device.

The association of the communication address and geographical location may be performed, for example, by merely selecting a particular communication address previously stored in the mobile wireless communication device when the user is at the geographical location corresponding to that of the selected number. For example, when the user is at work, the user inputs or selects the work telephone number, which may be stored or entered in a soft telephone directory on the mobile wireless communication device.

In one embodiment, the telephone number directory or list includes, for each telephone number entry, an option to designate the number as a call forwarding number.

Upon inputting or selecting a communication address as a forwarding address, the mobile wireless communication device generates a location fix, and associates the location fix with the input or selected telephone number.

In one cellular communication system application, the location fix is generated by identifying a strongest base-station or control channel signal. The location of the cellular mobile wireless communication device thus corresponds generally the geographical area of the base station with the strongest signal. In another embodiment, the mobile wireless communication device is enabled with a Global Positioning System (GPS) sensor and measurement unit for generating a GPS location fix. In this latter embodiment, the geographical location of the mobile wireless communication device is a GPS based location fix, which may be obtained with or without terrestrial assistance.

The association or some indicium thereof is also stored on the phone. In an AMPS cellular communication network, for example, a control channel and digital color code value may be stored in association with the corresponding forwarding communication address. In a CDMA cellular communication network, a paging channel and a Pn value may be stored in association with the corresponding forwarding communication address. Other cellular communication networks may store other information to associate forwarding addresses with corresponding locations.

Other forwarding communication addresses may be entered or selected for other locations when the mobile wireless communication device is at the other locations, for example, home, vacation home, etc. In some embodiments, the user may be able to also specify a range associated with a particular location, for example by inputting a radius, e.g., 1 mile.

In other embodiments, users associate forwarding communication addresses with corresponding locations by entering the location fix manually, for example, by entering longitude and latitude location data, or an input corresponding to a base station address, or some other location identification information. According to this alternative, forwarding communication addresses may be associated with corresponding locations without first traveling to each location where a forwarding communication address is selected.

In FIG. 1, inputting or generating the location fix is indicated at block 120, and the inputting/selecting of the corresponding forwarding communication address is indicated at block 130. The particular sequence of steps 120 and 130 is immaterial, since generally either step may be performed first, or in some embodiments both may be performed simultaneously.

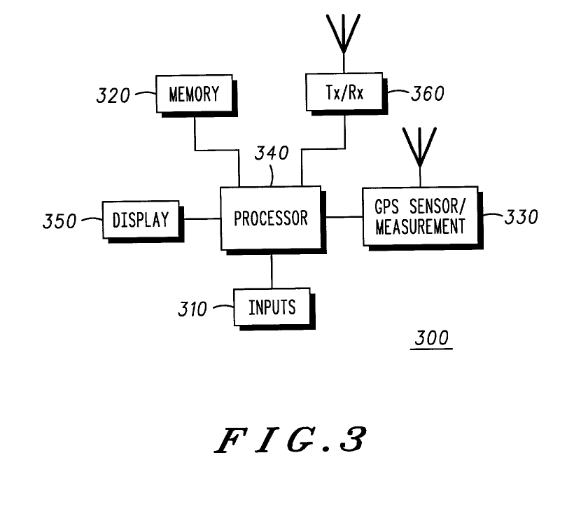

In FIG. 3, an exemplary mobile wireless communications device 300 includes an input 310, for example a keypad, for inputting communications addresses and other data, including names, and in some embodiments corresponding location information associated therewith, all of which is stored in memory 320. The exemplary mobile wireless communication device is enabled with a GPS sensor and measurement unit 330. A processor 340 controls the operation of the device including a display 350 and a receiver/transmitter 360.

Typically, users of mobile wireless communication devices forward incoming communications when the device is power down. Thus in some implementations of the present invention, incoming wireless communications are automatically forwarded to another location dependent communication address when the mobile wireless communications device is powered down, as discussed more fully below.

In other implementations, incoming wireless communications may be forwarded automatically to a location dependent communication address on some basis other than power down, for example, in areas where service is unavailable. In this exemplary scenario the incoming wireless communication may be forwarded to a communication address corresponding to or associated with a last known location, e.g., a most recent GPS based location fix or serving base station, of the device stored in memory thereof.

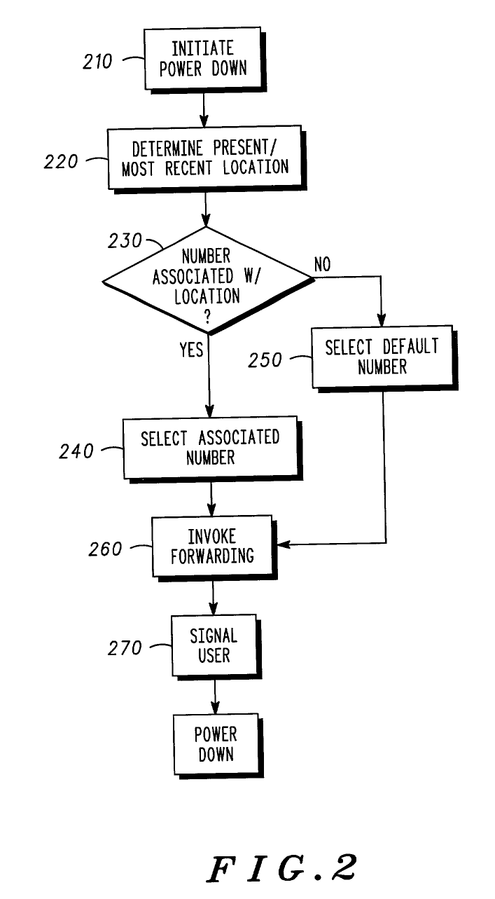

In the exemplary flow diagram of FIG. 2, at block 210, the user initiates power down of the mobile wireless communication device, for example, by depressing an “OFF” key or some corresponding soft input. At block 220, the location of the mobile wireless communication device is determined, for example a new GPS location fix is generated, or a most recently stored GPS location fix is used if it was generated only recently, for example within a predetermined time period, which may take into consideration the velocity of the mobile device.

In FIG. 2, at block 230, it is determined whether a forwarding communication address has been associated with the present or most recent location of the mobile wireless communication device determined at block 220. At block 240, if a forwarding communication address, for example, a telephone number, is associated with the present location, the number is selected for forwarding. At block 250, if a forwarding communication address has not been associated with the present location, a default forwarding address may be selected. The default address also includes no forwarding communication address.

In FIG. 2, at block 260, the forwarding feature is invoked for the communication address selected. In a cellular handset, for example, block 260 corresponds functionally to dialing “*72”, the forwarding number and the “send” key, as is performed manually in prior art cal forwarding schemes. In the present invention however this step is performed automatically, under software control.

In some embodiments, the mobile wireless communication device signals the user prior to power down, as indicated a block 270, for example to indicate whether call forwarding was successful or to display the number to which incoming calls will be forwarded. Thereafter, the device is powered down at block 280.

In another embodiment of the invention, in mobile wireless communication devices in which incoming wireless communications are forwarded during power down, as discussed hereinabove, the forwarding of wireless communications is disabled upon re-powering the mobile wireless communication device. In one embodiment, the forwarding feature is automatically disabled upon re-applying power to the device, without further input by the user. In another embodiment, the user is prompted upon power-up, for example with an audible or vibratory alert, to manually disable the forwarding feature. In this later embodiment, the mobile wireless communication device is used exclusively for outgoing communications.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method for forwarding incoming calls in a mobile wireless communication device, comprising:
determining a location of the mobile wireless communication device;
determining, at the mobile wireless communication device, whether one of a plurality of telephone numbers stored on the mobile wireless communication device in association with corresponding locations has been associated with the location of the mobile wireless communication device;
if a telephone number as been associated with the location of the mobile wireless communication device, forwarding incoming calls to the telephone number associated with the location of the mobile wireless communication device.

2. The method of claim 1, forwarding calls to a default telephone number stored on the mobile wireless communication device if a forwarding number has not been associated with the location of the mobile wireless communication device.

3. The method of claim 1, initiating power down of the mobile wireless communication device before determining whether a telephone number has been associated with the location of the mobile wireless communication device, forwarding calls to the telephone number associated with the location of the mobile wireless communication device before power down of the mobile wireless communication device.

4. The method of claim 3, providing call forwarding confirmation after forwarding calls and before power down of the mobile wireless communication device.

5. The method of claim 1, determining a location of the mobile wireless communication device based upon base station signal strength received at the mobile wireless communication device.

6. The method of claim 1, storing a plurality of telephone numbers on the mobile wireless communication device, associating at least some of the stored numbers with a location, storing indicia of the associations on the mobile wireless communication device.

7. The method of claim 1, forwarding calls upon powering down the mobile wireless communication device.

8. A method for forwarding wireless communications in a mobile wireless communication device, comprising:
storing a plurality of communication addresses in association with corresponding geographical areas on the mobile wireless communication device;
determining at the mobile wireless communication device whether a stored communication address has been associated with a geographical location of the mobile wireless communication device;
forwarding wireless communications to a communication address associated with the geographical location of the mobile wireless communication device.

9. The method of claim 8, determining whether a stored communication address has been associated with a most recently determined geographical location of the mobile wireless communication device.

10. The method of claim 8, determining whether a stored communication address has been associated with geographical location of the mobile wireless communication device upon initiating power down of the mobile wireless communication device.

11. The method of claim 8, forwarding wireless communications to a default communication address stored on the mobile wireless communication device when the mobile wireless communication device is powered down if a communication address has not been associated with the geographic location of the mobile wireless communication device.

12. The method of claim 8, forwarding wireless communications to the communication address associated with the geographical location of the mobile wireless communication device when the mobile wireless communication device is powered down.

13. The method of claim 8, in a mobile wireless communication device in which wireless communications are forwarded to a communication address associated with a geographical location of the mobile wireless communication device upon power down of the mobile wireless communication device, disabling the forwarding of wireless communications upon re-powering the mobile wireless communication device.

14. The method of claim 8, initiating power down of the mobile wireless communication device before forwarding wireless communications to the communication address associated with the geographical location of the mobile wireless communication device.

15. The method of claim 14, providing a forwarding confirmation signal before powering down of the mobile wireless communication device.

16. The method of claim 10, associating communication addresses with corresponding geographical locations within a specified radius of a location fix.

17. The method of claim 10, associating communication addresses with corresponding geographical locations served by corresponding base-stations of a cellular communication network.

18. A mobile wireless communication device, comprising:
a processor;
a transmitter and receiver coupled to the processor;
a memory coupled to the processor, the memory for storing a plurality of communication addresses in association with corresponding geographical locations;
means for determining a geographical location of the mobile wireless communication device;
the processor for determining whether a communication address is associated with a geographical location of the mobile wireless communication device,
the processor for forwarding incoming wireless communications to a communication address associated with the geographical location of the mobile wireless communication device.

19. The mobile wireless communication device of claim 18 is a Global Positioning System (GPS) enabled mobile wireless communication device, the means for determining a geographical location of the mobile wireless communication device includes GPS sensor and measurement device.

20. The mobile wireless communication device of claim 19 is a cellular communication handset.
